(19) United States
(12) Patent Application Publication
(10) Pub. No.: US 2002/0009928 A1
(43) Pub. Date: Jan. 24, 2002

(54) Connector device for card with a plurality of connection terminals different in length

(75) Inventor: Wataru Oguchi, Miyagi-ken (JP)

Correspondence Address: BEYER WEAVER & THOMAS LLP, P.O. BOX 778, BERKELEY, CA, 94704-0778, US

(73) Assignee: ALPS ELECTRIC CO., LTD.

(21) Appl. No.: 09/886,316

(22) Filed: Jun. 19, 2001

(30) Foreign Application Priority Data
Jul. 6, 2000 (JP) 2000-210698

(51) Int. Cl. H01R 24/00

(52) U.S. Cl. 439/630

(57) ABSTRACT

According to the present invention, a connector device for card in which supporting positions of the respective connection terminals with respect to the header are formed on the same straight line without being shifted forward and backward and rigidity of the respective supporting portions get greater as the length to the contact portion gets greater, so that the contact pressures of the respective connection terminals are uniform and the miniaturization of the whole connector device can be accomplished, is provided. The connector device for card comprises a header 3 provided side by side with a plurality of connection terminals 2 made of conductive metal plate; and a frame 1 which the header 3 is arranged at one end thereof and which a card 5 with a plurality of contacts 5a capable of being connected to the connection terminals 2 is fitted, wherein the connection terminals 2 are provided with a supporting portion 2a supported to the header 3 and a contact portion 2c elastically contacted with the contact 5a of the card at a free end extended from the supporting portion 2a, respectively, and wherein the connection terminals 2 are so formed that the supporting portions 2a are provided side by side on the same straight line having a direction perpendicular to a card-inserting direction, that lengths from the supporting portions 2a to the contact portions 2c are formed differently and at the same time, and that as the length from the supporting portion 2a to the contact portion 2c gets longer, rigidity of the supporting portion 2a get greater.

### BACKGROUND OF THE INVENTION

1. Field of the Invention

The present invention relates to a structure of a connector device for card used in IC card which is used in a memory medium such as a personal computer, or MMC (Multi Media) card which is used in an electronic equipment and the like such as a digital camera.

2. Description of the Related Art

Connector devices for IC card are generally used as a recording device additionally installed to a personal computer and the like. As a memory medium of the connector device for IC card, IC card has been used widely.

The IC card is fitted into the connector device for IC card to carry out write and read of necessary information, in which a plurality of contacts are provided in the IC card and a header in which connection terminals having a plurality of contact portions corresponding to arrangement positions of the plurality of contacts are provided side by side, are provided in the connector device for IC card side. Also, in the header, a plurality of solder portions soldered to a circuit pattern portion of a circuit board to which the connector device for IC card is adhered are projected and formed, and the respective contact portions and the respective solder portions become electrically connected states within the header, respectively.

Also, among the IC cards, there are IC cards in which in order to prevent the destruction of an internal IC circuit of the IC card due to an inrush current and the like in being connected to connection terminals, a connection sequence with the respective connection terminals is prescribed. In general, a method for prescribing the connection sequence is carried out by making connecting positions of the contact portions of the respective connection terminals on the connector device for IC card side and the contacts on the IC card side to be different.

In order to make the connecting positions of the contact portions of the respective connection terminals and the contacts on the IC card to be different, supporting positions of the respective connection terminals with respect to the header on the connector for IC card side were corresponded by shifting forward and backward properly to be matched in the IC card-inserting direction.

However, in the structure of the header of the conventional connector device for IC card described above, there is a problem that the length of the supporting portion of the connection terminal of the header gets longer and thus miniaturization of the whole connector device cannot be accomplished, because the supporting positions of the respective connection terminals are shifted forward and backward.

Also, in order to correspond the supporting positions of the respective connection terminals without shifting forward and backward, there is a method of making the lengths from the supporting positions of the respective connection terminals to the contact portions to be different, but this method has a problem that contact pressures on the contacts of the IC card can be changed according to the lengths, in that the lengths from the supporting positions of the respective connection terminals to the contact portions are different.

Therefore, the present invention is made in order to solve the above problems, and thus an object of the present invention is to provide a connector device for card in which in the structure of the connector device for card, supporting positions of the respective connection terminals with respect to the header are formed on the same straight line without being shifted forward and backward and rigidity of the respective supporting portions get greater as the length to the contact portion gets longer, so that the contact pressures of the respective connection terminals are uniform and the miniaturization of the whole connector device can be accomplished.

### SUMMARY OF THE INVENTION

In a first means for solving the above problems according to the present invention, a connector device for card comprising: a header provided side by side with a plurality of connection terminals made of conductive metal plate; and a frame which the header is arranged at one end thereof and which a card with a plurality of contacts capable of being connected to said connection terminals is fitted, wherein said connection terminals are provided with a supporting portion supported to said header and a contact portion elastically contacted with the contact of the card at a free end extended from the supporting portion, and wherein said connection terminals are so formed that said supporting portions are provided side by side on the same straight line having a direction perpendicular to a card-inserting direction, that lengths from said supporting portions to said contact portions are formed differently and at the same time, and that as the length from said supporting portion to said contact portion gets longer, rigidity of said supporting portion gets greater, is provided.

Also, in a second means according to the present invention, said connection terminals are so formed that said supporting portions are provided side by side on the same straight line having a direction perpendicular to a card-inserting direction, that lengths from said supporting portions to contact portions are formed differently and at the same time, and that as the length from said supporting portion to the contact portion gets longer, a width of said supporting portion gets wider.

Also, in a third means according to the present invention, said header is arranged at a front end in the card-inserting direction of said frame and said connection terminals are provided with solder portions which are projected from a front side of said header to be soldered to a circuit board.

Also, in a fourth means according to the present invention, said connection terminals are integrally molded in said header through said supporting portion.

### BRIEF DESCRIPTION OF THE DRAWINGS

The above objects, other objects, features and advantages of the present invention will be better understood from the following description taken in conjunction with the accompanying drawings, in which:

FIG. 1 is a plan view showing a connector device for card according to an embodiment of the present invention;

FIG. 2 is a side view showing the connector device for card according to an embodiment of the present invention;

FIG. 3 is a front view showing the connector device for card according to an embodiment of the present invention;

FIG. 4 is a partial plan view showing a header of the connector device for card according to an embodiment of the present invention;

FIG. 5 is a plan view showing an IC card according to an embodiment of the present invention;

FIG. 6 is a plan view showing a state that the IC card is fitted into the connector device for card according to the present invention;

FIG. 7 is a partial cross-sectional view showing a state that the IC card is fitted into the connector device for card according to the present invention; and

FIG. 8 is a partial cross-sectional view showing an initial state during the IC card is inserted into the connector device for card according to the present invention.

### DETAILED DESCRIPTION OF THE PREFERRED EMBODIMENT

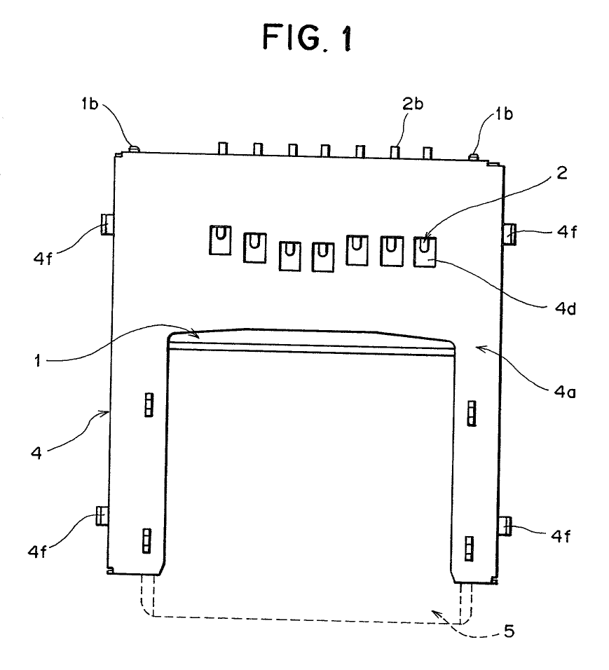

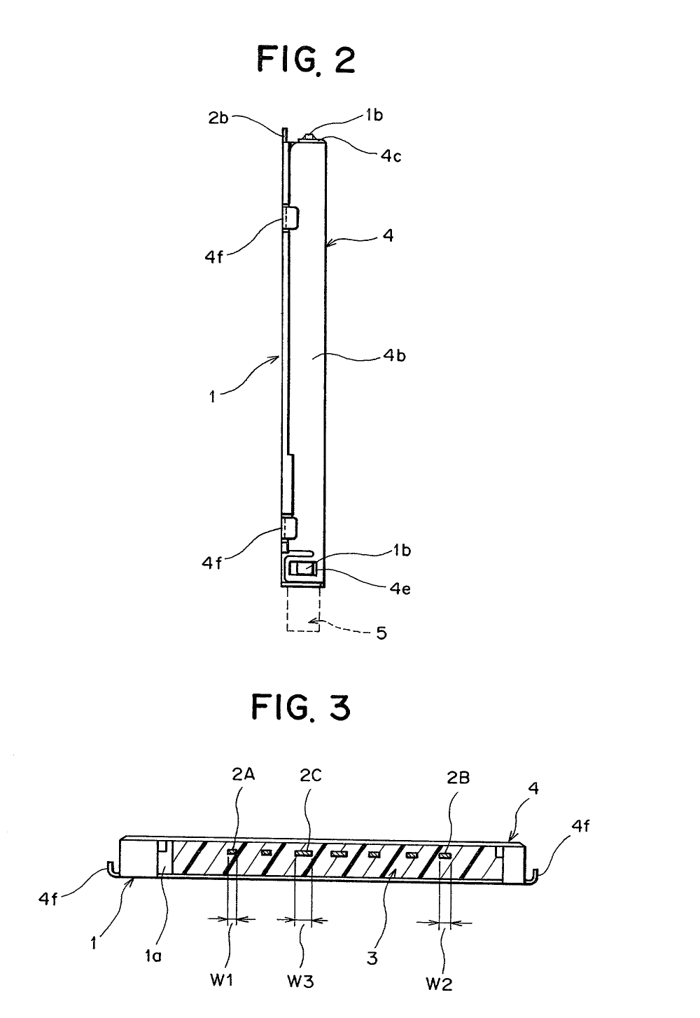

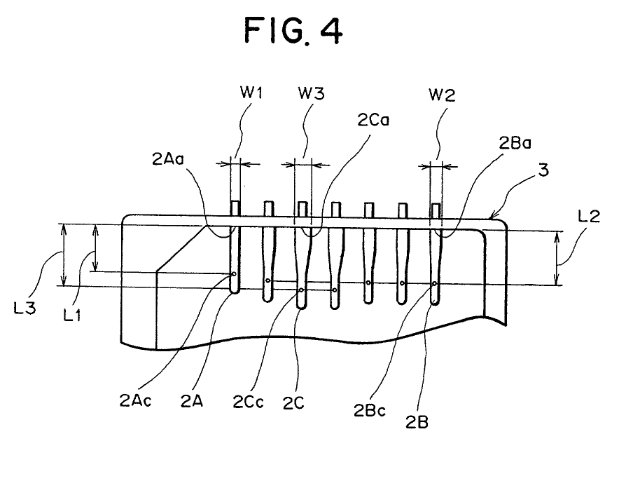

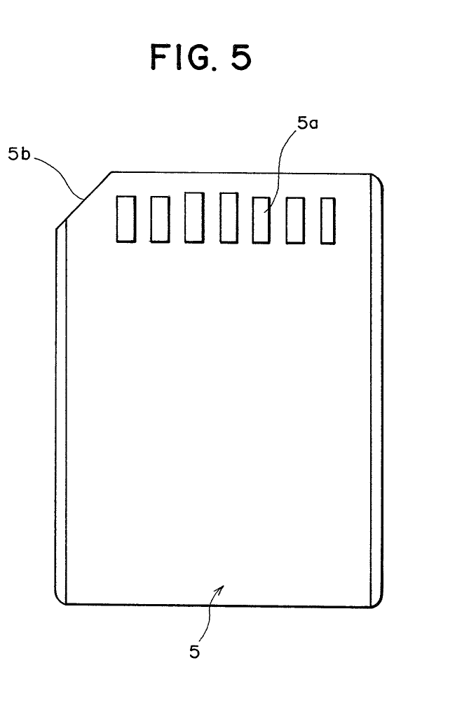

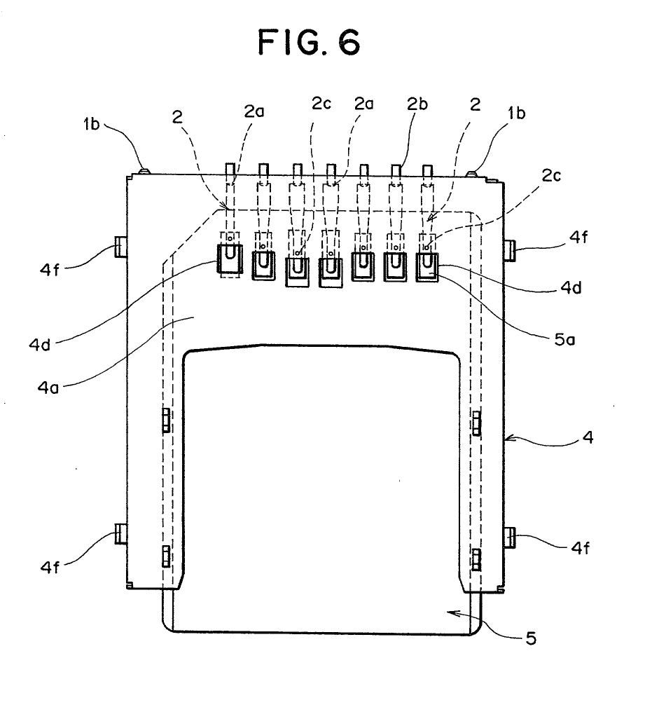

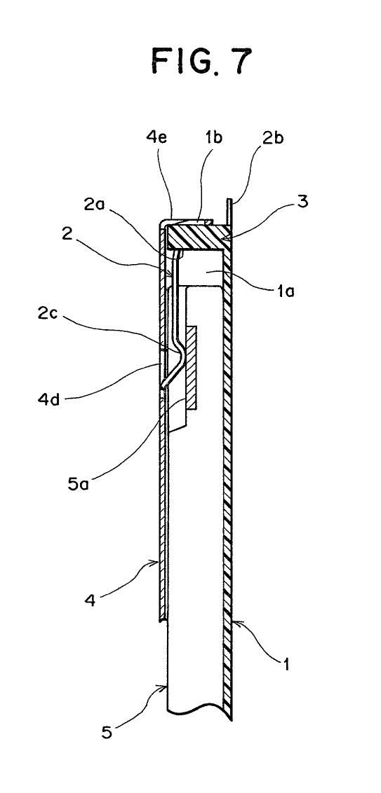

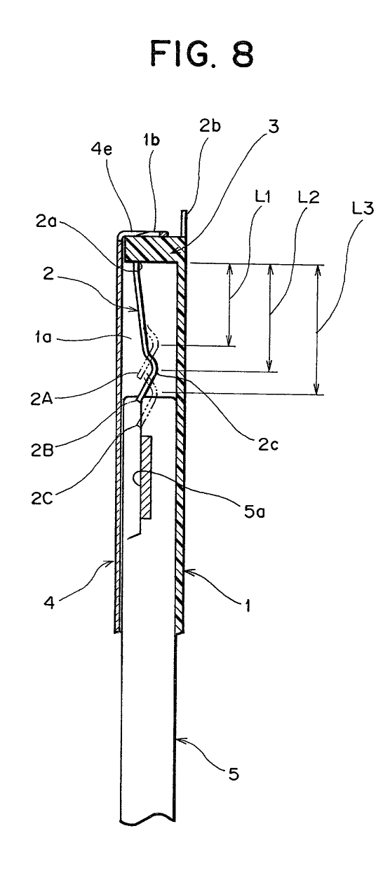

Now, an embodiment of the present invention will be explained based on examples with reference to FIGS. 1 to 8. FIG. 1 is a plan view of a connector device for card, FIG. 2 is a side view of the connector device for card, FIG. 3 is a front view of the connector device for card, FIG. 4 is a plan view of a header, FIG. 5 is a plan view of an IC card, FIG. 6 is a plan view showing a set-in state of the IC card, FIG. 7 is a partial cross-sectional view showing the set-in state of the IC card, and FIG. 8 is a cross-sectional view showing an initial inserting state of the IC card.

In the drawings, a frame 1 is made of insulating material such as synthetic resins and the like and is formed in a box shape of which a top surface and a front surface are opened. At the center of the frame 1, a receiving portion 1a which IC card 5 to be described later is fitted is formed, and at the front end side, a header 3 in which a plurality of connection terminals 2 made of conductive metal plate are provided side by side. The header 3 is integrally formed with the frame 1. However, they may be formed separately and engage with each other to form an integral body.

Also, at the front surface end and the side surface end of the frame 1, engagement projections 1b for engaging with a cover member 4 to be described later are formed.

The supporting portions 2a are integrally molded in the header 3 by means of methods such as insert molding and the like to support the connection terminals 2. Also, at one end of the connection terminals 2, solder portions 2b which are projected toward the outside of the frame 1 from the header 3 to be soldered to circuit patterns of a circuit board installed to electronic equipment and the like not shown are provided, and at free ends, i.e., the other ends of the solder portions 2b, contact portions 2c connected to contacts 5a of the IC card 5 to be described later are provided. Also, the solder portions 2b and the contact portions 2c are electrically connected through the supporting portions 2a within the header 3.

Also, as shown in FIG. 4, the connection terminals 2 are supported to the header 3 so that the supporting portions 2a are provided side by side on the same straight line having a direction perpendicular to the inserting direction of the IC card 5, and the lengths from the supporting portions 2a to the contact portions 2c are formed to be properly different. That is, a connection terminal 2A formed to be shortest (shown as L1) and positioned at the left end side, a connection terminal 2B formed to be little longer (shown as L2) than the connection terminal 2A and a connection terminal 2C formed to be longest (shown as L3) and positioned at the center side are formed.

Also, in the connection terminals 2, the width of the supporting portions 2a are so formed to be properly different that as the lengths from the supporting portions 2a to the contact portions 2c get longer, rigidity of the supporting portions 2a get greater and that as the lengths from the supporting portions 2a to the contact portions 2c provided on the free end side get longer, the widths of the supporting portions 2a get wider. That is, a width (W2) of a supporting portion 2Ba of a little longer (L2) connection terminal 2B is formed to be wider than a width (W1) of a supporting portion 2Aa of the shortest (L1) connection terminal 2A, and a width (W3) of a supporting portion 2Ca of the longest (L3) connection terminal 2C is formed to be more wider.

By means of the above construction, when the respective contact portions 2c of the connection terminals 2 are connected to the respective contacts 5a of the IC card 5, because the connecting positions of the contacts 5a and the contact portions 2c of the connection terminals 2 to be connected can be set properly different, the connection sequence structure of the respective connection terminals 2 can be obtained with a simple structure.

Also, it is not necessary to shift the positions of the supporting portions 2a for supporting the connection terminals 2 on the header 3, the lengths of the supporting portions 2a of the connection terminals 2 do not get longer and because the widths (W1<W2<W3) of the supporting portions 2a are formed wider as the lengths (L1<L2<L3) from the supporting portions 2a to the contact portions 2c formed to be wider, the respective connection terminals 2A, 2B, 2C do not have non-uniform contact pressures according to the length, the contact pressures of the respective contact portions 2Ac, 2Bc, 2Cc can be uniform and the header 3 can be formed small, thereby to accomplish miniaturization of the connector device.

Moreover, in the above embodiment, the supporting portions 2c are so formed that as the lengths from the supporting portions 2a of the connection terminals 2 to the contact portions 2c get longer, the widths are formed to be getting wider. However, as described above, it is preferable that as the lengths from the supporting portions 2a to the contact portions 2c get longer, rigidity of the supporting portions 2a get greater, and for this purpose, as the lengths from the supporting portions 2a to the contact portions 2c get longer, the plate thickness of metal material of the connection terminals forming the supporting portions 2a the connection terminals 2 may be thicker. Also, using the same plate thickness of the metal material, reinforcing ribs may be formed on the supporting portions 2a by means of methods such as a press process and the like.

In this case, in order to improve rigidity of the supporting portions 2a when the thickness of metal material plate is changed, if the widths are the same, the rigidity gets greater as the plate thickness gets thicker, and when the thickness is the same, the rigidity can be ensured by increasing the number of the reinforcing ribs or enlarging the dimension of the ribs.

In the above construction, the same advantages as the above embodiment can be also obtained.

The cover member 4 is formed in a U-shape made of conductive material and consists of a top plate portion 4a having a flat shape, side plate portions 4b facing each other and a front plate portion 4c. A plurality of window hole portions 4d are provided in the top plate portion 4a and free ends of the connection terminals 2 are arranged to face the window hole portions 4d, in which when the connection terminals 2 are bent by insertion of IC card 5 to be described later, front ends of the free ends are formed to be projected from the window hole portions 4d to obtain sufficient elastic force.

Also, the cover member 4 is engaged on the frame 1 to cover the receiving portions 1a of the frame 1 and the connection terminals 2, and in the side plate portions 4b and the front plate portion 4c, engagement holes 4e for engaging with the respective engagement projections 1b provided in the front surface ends of the frame 1 and the side surface ends are formed. Also, in the side plate portions 4b, earth terminals 4f are provided, and shield of the IC card and the connector device for card is carried out by connecting the earth terminals 4f to earth patterns of the circuit board installed to electronic equipment and the like not shown.

The IC card 5 in which integrated circuit (IC) is received is widely used as a recording medium. On one surface side of the IC card 5, a plurality of contacts 5a are formed at an end thereof, the contacts 5a are received in the receiving portions 1a of the frame 1, and by getting contact with the contact portions 2c of the plurality of connection terminals 2 arranged in the header 3, various information processing with electronic equipments which are connected to the outside can be carried out.

Also, in the IC card 5, a recess portion 5b of a sloped surface shape is provided on one corner portion of formation side of the contacts 5a. By engaging a slide member not shown on the recess portion 5b, the IC card 5 is fitted into the frame 1 through the slide member and is held at the fit position by a lock member not shown.

Next, the structure of the connection sequence of the respective connection terminals 2 in the above embodiment will be explained with reference to FIG. 6 to FIG. 8.

First, when the IC card 5 is inserted into the receiving portion 1a of the frame 1, because the respective contacts 5a of the IC card 5 are provided side by side on the same straight line perpendicular to the inserting direction of the IC card 5, the contacts 5a are connected to the connection terminal 2C formed longest (L3) among the respective connection terminals 2. At that time, other contacts 5a of the IC card 5 are in non-connected state.

At that time, because a load current such as an inrush current and the like from the connection terminal 2C is set not to flow to the input side of a microcomputer and the like built in the IC card 5, the destruction of the IC card 5 due to the inrush current in connection of the IC card 5 can be prevented.

In this state, when the IC card 5 is pressed in the inserting direction, successive to the connection terminal 2C, the connection terminal 2B formed secondly long (L2) is connected to a portion of other contacts 5a in non-connected state. At that time, in that current is already supplied through the connection terminal 2C to main circuit portion of the IC card 5, the circuit is in driving state and new inrush current is not generated, and because steady and constant current flows on the input side of microcomputer and the like, the concern for destroying the IC card 5 in connection has been disappeared.

Also, when the IC card 5 is inserted to the fit position, successive to the connection terminals 2B, the shortest connection terminal 2A and the last contacts point portions 5a are connected to each other and connection of the IC card 5 and the respective connection terminals 2 is completed.

In this case, the connection terminals 2 are so formed that the lengths from the supporting portions 2a to the contact portions 2c are different, respectively, wherein as the lengths from the supporting portions 2a to the contact portions 2c get longer, the widths of the supporting portions 2a get wider, and in that respective contact pressures of the contact portions 2Ac, 2Bc, 2Cc of the connection terminals 2A, 2B, 2C are formed to be the same, respectively, the respective contacts 5a of the IC card 5 and the respective connection terminals 2A, 2B, 2C are connected to each other in a stable state with the same contact pressure.

According to the above embodiment, the respective connection terminals 2 and the contacts 5a of the IC card 5 are connected to each other always in the stable state without having variation of contact pressure, and when the respective contact portions 2c of the connection terminals 2 are connected to the respective contacts 5a of the IC card 5, the connecting positions of the contacts 5a and the contact portions 2c of the connection terminals 2 to be connected can be properly different and thus connection of the IC card in which the connection sequence is prescribed can be corresponded with a simple structure.

As explained above, the connector device for card according to the present invention comprises a header provided side by side with a plurality of connection terminals made of conductive metal plate; and a frame which the header is arranged at one end thereof and which a card with a plurality of contacts capable of being connected to the connection terminals is fitted, wherein the connection terminals are provided with a supporting portion supported to the header and a contact portion elastically contacted with the contact of the card at a free end extended from the supporting portion and wherein the connection terminals are so formed that the supporting portions are provided side by side on the same straight line having a direction perpendicular to a card-inserting direction, that lengths from the supporting portions to the contact portions are different and at the same time, and that as the length from the supporting portion to the contact portion gets longer, rigidity of the supporting portion gets greater. Therefore, it dose not occur that the contact pressures are non-uniform according to the length of the respective connection terminals and thus the contact pressures of the respective contact portions can be the same, thereby to provide the connector device for card corresponding to connection of the IC card prescribing the connection sequence.

Also, the connection terminals are so formed that the supporting portions are provided side by side on the same straight line having a direction perpendicular to a card-inserting direction, that lengths from the supporting portions to the contact portions are formed differently and at the same time, and that as the length from the supporting portion to the contact portion gets longer, a width of the supporting portion gets wider. Therefore, like the above, it dose not occur that the contact pressures are non-uniform according to the length of the respective connection terminals and thus the contact pressures of the respective contact portions can be the same, thereby to provide the connector device for card corresponding to connection of the IC card prescribing the connection sequence, with a simple structure.

Also, the header is arranged at a front end in the card-inserting direction of the frame and the connection terminals are provided with solder portions which are projected from a front side of the header to be soldered to a circuit board. Therefore, the terminal supporting portions of the connection terminals in the header can be formed small, thereby to accomplish the miniaturization of the whole connector device.

Also, the connection terminals are integrally molded in the header through the supporting portion, and thus it is ensured that the supporting portions are supported to the header, thereby to obtain a stable pressure on the contact portions.

Also, those who are skilled in the art will appreciate that various modifications, additions and substitutions are possible without departing from the scope and spirit of the present invention. Therefore, it should be understood that the present invention is limited only to the accompanying claims and the equivalents thereof, and includes the aforementioned modifications, additions and substitutions.

What is claimed is:

1. A connector device for card, comprising:
a header provided side by side with a plurality of connection terminals made of conductive metal plate; and
a frame which the header is provided at one end thereof and which a card with a plurality of contacts capable of being connected to said connection terminals is fitted,
wherein said connection terminals are provided with a supporting portion supported by said header and a contact portion elastically contacted with the contact of the card at a free end extended from the supporting portion, and
wherein said connection terminals are so formed that said supporting portions are provided side by side on the same straight line having a direction perpendicular to a card-inserting direction, that lengths from said supporting portions to said contact portions are formed differently and at the same time, and that as the length from said supporting portion to said contact portion gets longer, rigidity of said supporting portion get greater.

2. A connector device for card according to claim 1, wherein said connection terminals are so formed that said supporting portions are provided side by side on the same straight line having a direction perpendicular to a card-inserting direction, that lengths from said supporting portions to said contact portions are formed differently and at the same time, and that as the length from said supporting portion to said contact portion gets greater, a width of said supporting portion gets wider.

3. A connector device for card according to claim 1, wherein said header is arranged at a front end in the card-inserting direction of said frame and said connection terminals are provided with solder portions which are projected from a front side of said header to be soldered to a circuit board.

4. A connector device for card according to claim 1, wherein said connection terminals are integrally molded in said header through said supporting portion.
